(19) United States
(12) Patent Application Publication
(10) Pub. No.: US 2004/0088236 A1
(43) Pub. Date: May 6, 2004

(54) Method and apparatus for investment consulting, benefit projection and investment analysis

(76) Inventor: Kathleen E. Manning, Chicago, IL (US)

Correspondence Address: SCHIFF HARDIN, LLP, PATENT DEPARTMENT, 6600 SEARS TOWER, CHICAGO, IL, 60606-6473, US

(21) Appl. No.: 10/284,663

(22) Filed: Oct. 31, 2002

(51) Int. Cl. G06F 17/60

(52) U.S. Cl. 705/35

(57) ABSTRACT

A method and software product provide an analysis and modeling of retirement investments during a pre-retirement accumulation phase and a post-retirement distribution phase. Investment returns are detailed and investment scenarios are presented, including good returns first, bad returns first, historical period modeling, and user selectable return modeling. All investment and benefit sources of a user are considered. Annuity purchase options, cost of living increases, distribution strategies, threshold driven annuity options as a bailout and tax effects upon the accumulation and distribution phases aid in development of a strategy development in the modeling process.

### BACKGROUND OF THE INVENTION

1. Field of the Invention

The present invention relates generally to a financial modeling and analyzing structure for forecasting, projecting, modeling, and simulating potential cash flows through the accumulation and distribution process and multiple time periods and to a corresponding method. In particular, the invention models pre-retirement capital accumulation and post-retirement investment and distribution.

2. Description of the Related Art

Individuals planning their retirement are left to the uncertainties of the future while struggling to make sense of financial data and recommendations. An individual must determine how much to invest, in what investments, and when to change those investments. The individual does not know how long the money will be needed and is faced with the prospect of outliving his or her money. The individual may be unaware of the effects of the tax laws on investments, may not know of the variations in social security benefits for income changes, and may not be considering some of the capital resources available to the individual.

A typical individual has a working life during which portions of the individual's pay is put into investment accounts. This is referred to as an accumulation period or pre-retirement period. When the individual retires, the contributions from the individual's pay cease and the individual looks to begin drawing funds from the investment accounts. This is referred to as a distribution period or post-retirement period. The investment decisions for the individual are different between the accumulation period and the distribution period, but the individual may not realize the implications of the different decisions, nor the options available to the individual. The individual must determine a distribution strategy during the distribution period that does not deplete the account balances while they are still needed, regardless of the investment returns during the accumulation period and the distribution period. Depletion of the retirement funds while the person is still alive and relying on them is referred to as ruin theory.

### SUMMARY OF THE INVENTION

The present invention assists the user in planning and projecting sources of retirement income and in making decisions during the accumulation (or pre-retirement) period including determining future contributions and investments and before and during the distribution (or post-retirement) period about amounts of withdrawals and all types of investments. The method and software of the invention integrates, projects, models and simulates all types of capital accumulation, retirement benefits, and employee benefit retirement plans for a specific individual or user. Amounts are modeled and simulated throughout the accumulation phase, at retirement, and throughout the distribution phase, and various strategies are offered to the user between risky and non-risky assets and guaranteed assets, including the strategy of obtaining annuities and/or guaranteed financial vehicles, at various times in the process. Modeling of the outcome is performed by applying different economic variables to the data and changing those variable to see the effects that have on the end result. In a preferred embodiment, the modeling is done by application of economic data from a user selected historical period.

### BRIEF DESCRIPTION OF THE DRAWINGS

FIG. 1 is a functional block diagram of a first portion of the method of the present invention for guiding an individual or other user during an accumulation period, or pre-retirement period;

FIG. 2 is functional block diagram of a second portion of the present method showing an overview of a distribution, or post-retirement, period analysis;

FIG. 3 is a functional block diagram showing elements of the distribution analysis in greater detail; and

FIG. 4 is a functional block diagram showing further elements of the distribution period analysis according to the present method.

### DETAILED DESCRIPTION OF THE PREFERRED EMBODIMENTS

The present method and apparatus takes into account, projects and integrates all types of capital accumulation, including savings and investments, retirement and employee benefit plans, as well as government entitlement payments, such as social security or railroad retirement benefits, for that user. In a typical application, the employer related benefits and the government entitlement benefits of an individual are brought together in the modeling software with the user's own savings plans and after tax investments to determine the current resources. Future contributions are forecasted and amounts are projected through the accumulation phase to a retirement date and through a post-retirement distribution phase. The modeling is performed with input from a number of variables. Modeling includes effects of and variations in inflation, investment returns, tax rates, before tax and after tax contributions, tax qualified and non-tax qualified investment vehicles, taxes at rollover or distribution, salary changes, application of the social security formula for salary changes, etc.

An evaluation of the results at retirement is possible, in particular, by looking at the adequacy of the post-retirement income. Detailed analysis of the distribution phase is possible, including application of various investment and withdrawal scenarios. The effects of the variables are applied to the modeling of the distribution period as well. Options are included to model the purchase of annuities which guarantee fixed (or increasing) levels of income. The annuity purchase options proposed at retirement and potentially at different times during the retirement, or distribution, period is a strategy. A warning threshold level of the account balances may be reached and indicate or trigger a recommendation to consider an annuity purchase if the withdrawals and investment returns permit the accounts to fall below the threshold in order to guarantee minimum future cash flow.

For purposes of this invention, an annuity includes all life contingent annuities with death and without death benefit features intermediate and long term bonds, and other guaranteed investments and fixed return investments and annuity purchase prices are approximate values based upon commonly used actuarial mortality tables, interest rates, and expense loads.

Thus, the software performs three main functions, 1) identification and integration of current resources (including employer, government and self), 2) projection of amounts by modeling with variables, and 3) evaluation of the results including development of post-retirement distribution and investment strategies. The outcome is effected by inflation, investment returns, taxation effects, etc. which plays into the modeling and evaluation phases. Through the use of this software, the user has a structure in which to evaluate their retirement economics.

The apparatus of the present invention may be a computer program or software available to a user on a computer, via the Internet, on a network such as a Local Area Network (LAN) or Wide Area Network (WAN), or may be available on computer readable media, such as a CD-ROM, DVD, diskette, tape, or other media. The media may be magnetic media, optical media, opto-magnetic media, or other existing and as yet unknown media. The computer on which the software or programs is run can be the user's computer, an employer's computer, a library or other public use computer, or a borrowed computer. The computer may be a desktop computer, laptop computer, handheld computer or personal data assistant, or may be a workstation on a network, or other type of computing device.

The present invention includes not only the software program but also the product including the media having the software thereon.

The present invention may be used by an individual person to plan and model the individual's retirement. The method may also be used by a family or other group for financial planning of the wage earner's retirement or for some other goal. The present apparatus and method can be used by businesses to measure enterprise risk, to plan capital accumulation and spending such as for a project. The business can model the accumulation of the capital by applying, for example, an internal rate of return, then model the use of the capital. The user of the present method and apparatus can be an investor or investment group or company, a trustee or trust administrator, an employee of a company or the employer, a financial planning service, or a financial or economic study group or agency. For purposes of the present invention, the user may be any or all of the above, or any other entity seeking to model financial data.

The present method and apparatus utilizes data on capital accumulation. For purposes of the present invention, capital accumulation includes, but is not limited to, retirement accounts, and plans defined and referred to by the IRS sections authorizing them, such as 401(k) plans, 403(b), 457(b), 457(f) or 401(a) plans, individual retirement accounts (IRAs), defined benefits plans, pension plans, tax qualified and non-tax qualified plans, government payments including entitlement programs such as social security and railroad retirement benefits, independent retirement accounts, personal savings and investment accounts, trust beneficiary income, insurance capital accumulation plans, alimony, disability benefits, deferred payment plans. etc.

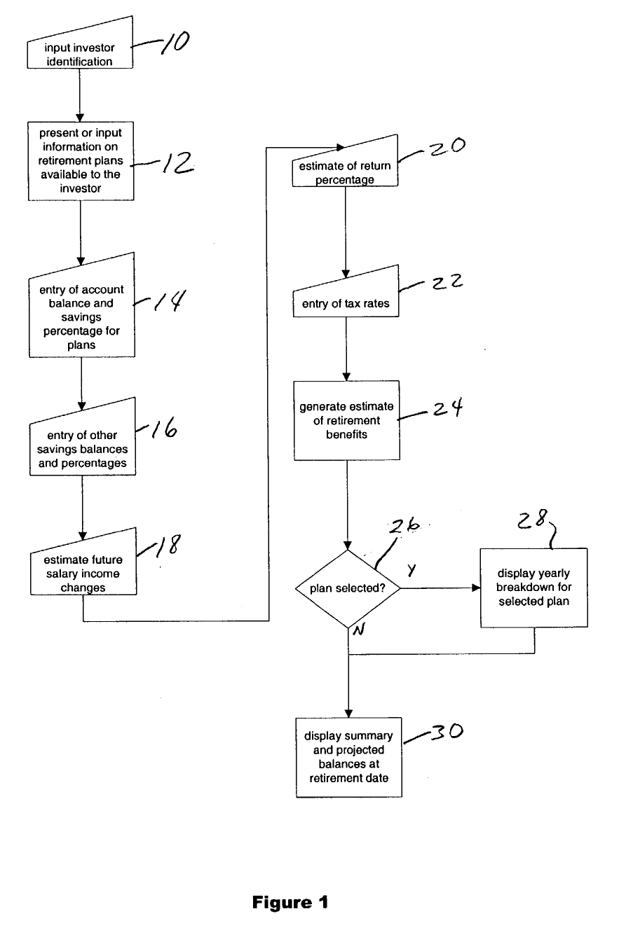

Referring to FIG. 1, the software program is started on a computer and the user is requested to input identification information, as shown at 10. The user of the present invention may be an individual or may be a business or other group or entity seeking to model financial information. This identification information may be a social security number, employee number, name or other identifier, preferably with a PIN (Personal Identification Number) as well. In a typical application of the invention, the software of the present invention is run on the user's computer, either at home or at work, and the software first asks the user to identify themselves by their social security number and a password.

The program starts by explaining its purpose to the user, to assist the user in understanding the user's benefits plans and in planning the user's financial future. The plan provides estimates of the user's retirement benefits under the user's employer plans and other plans and under social security, and assists in evaluation of the user's financial resources at retirement. Various combinations of assumptions are tested. The variable items under the program are: the investment rate of return to the allocation of assets, the future salary increases, the amounts (including savings and employer contributions) being put into the retirement plans (such as a 401(k) plan) as contributions, and the expected date of retirement.

The software charts the provisions of the retirement and investment plans; estimates income sources at retirement; experiments with potential investment returns, income amounts and durations of payment; explores investment strategies and asset allocations; and experiments with distribution and payout strategies.

At step 12, the investor is presented with the various investment plans available to the investor. The plans may include tax qualified pension plans, non-tax qualified plans, employee contribution plans, employer contribution plans, 401(k) plans, IRAs (Individual Retirement Accounts), after tax savings plans, insurance cash value accumulation plans, and the like. In one embodiment, the user is an employee of a company and the company offers use of the software to the employee for assistance in planning the employee's retirement. The software thus already includes the information and specifics on the retirement plans offered by the company.

For each of the plans covered by the software, information is provided on the type of plan, the eligibility requirements, the benefit amounts, when the benefits are payable and the vesting policy information. This information is presented in table form, in one embodiment.

The inventor is, thus, familiarized with the retirement and investment plans available to him or her so that the further analysis by the software is meaningful.

The software assists the investor in looking at estimated income sources at retirement, by projecting estimated retirement plan benefits. Current balance and savings percentage for the retirement plan is input by the user at block 14, as is other pretax and after tax savings balances and percentages at block 16. The user provides estimates for simulating the future income increases at block 18, future investment returns at 20, anticipated retirement date, and pre and post retirement tax rates at block 22. From this information, the projected retirement plan benefits are projected at block 24 and available for viewing and/or for printing by the user at block 28 provided the plan is selected by the user at block 26. Specifically, the projections for the defined benefit pension plan, 401(k) plan, 457(b) plan, 457(f) non-qualified supplemental plan after tax saving account, social security benefits, monthly projection of benefits, summary of retirement benefits and the input data are available, and can be displayed on a year-by-year breakdown. At block 30, the user is provided with a summary of the input data and the projected balances which result therefrom.

The user may change the input assumptions from this part of the software, which takes the user back to the preceding portions of the software. For example, the investor may input a greater or lesser amount as the periodic contribution into the savings or 401(k) plan and thereby see the effects of changes in contribution at different points in the investor's working life. The user may also alter rates of return, retirement date, prospective salary changes, etc. to determine what changes these have on the account balance available at retirement. Preferably, at any point in the software, the user may backtrack and change the input assumptions and so can see how changes in input affect the outcome.

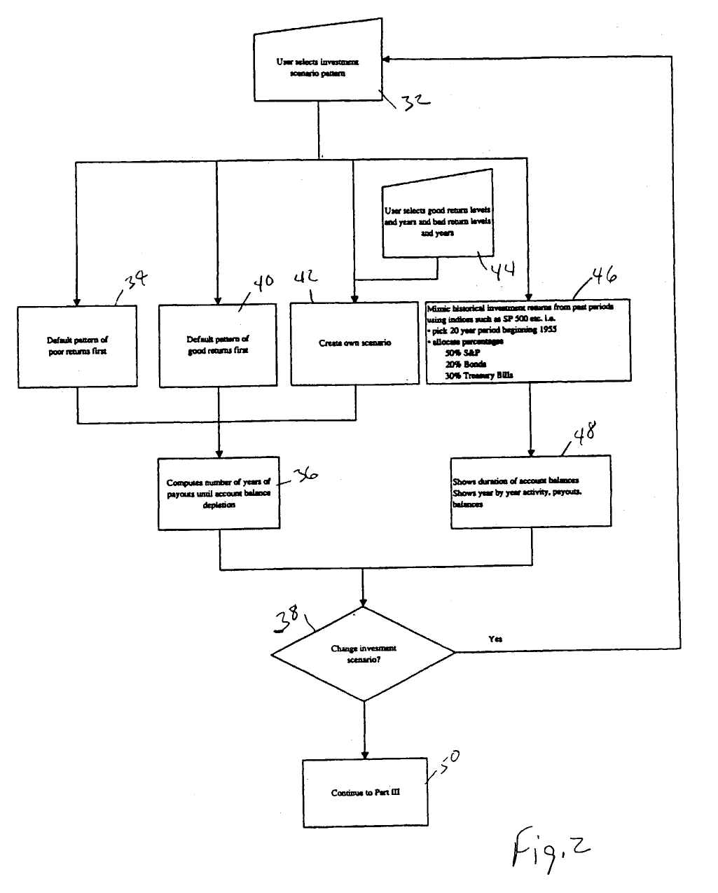

As shown in the overview of FIG. 2, in the second part of the software, the user can experiment with post retirement investment returns, income amounts and durations of payment for account balance plans. The user will have decisions to make regarding the distribution of your benefits under each of the plans. For example, the standard benefit under a pension plan is a life contingent annuity. Regardless of the annuity payment form selected, once the pension plan annuity starts, the user is guaranteed a level monthly income for at least the user's lifetime, no matter how long the user lives. There is no need to worry about investments if an annuity is purchased. The only pension plan decision to make at retirement is which annuity form to elect.

Other plans, such as a 401(k) plan, pay benefits in one single lump sum. At retirement, unless the user purchases an annuity from an insurance company, the adequacy of the user's account balances to provide income will depend upon the frequency and amount of withdrawals, the rate of return earned on the investments the user makes with the account balances, and the number of years the user and the user's survivors live. This section of the software includes exercises designed to assist the user in forecasting the after tax income of the retirement plan, 401(k) account balances and other account balances based upon hypothetical investment scenarios and withdrawal patterns. The models are designed to help the user get a feel for how sensitive the duration of the account balances are to variations in investment results and cash withdrawals and cost of living increases.

The user is provided with information on the account balances available on the forecasted retirement date. This information is drawn from the first portion of the software as illustrated in FIG. 1. The user is then offered the opportunity to experiment with post retirement investment returns, asset allocations, income amounts and durations of payment. These models illustrate the relationship between payouts, duration and investment return and asset allocation.

By way of an overview, the block 32 of FIG. 2 provides that the user selects the investment scenario. The first selection 34 is a default pattern of poor returns first, which if selected leads to a display of the number of years of payouts until the account balance is depleted, at 36. The investor is then requested to indicate whether they want to change the investment scenario, at 38. If yes, the investor is returned to the selection block at 32.

If the investor chooses the second option, a default pattern of good returns first, at block 40, the number of years is computed until depletion of the account balance at 36. The investor is then offered the opportunity, at 38, of returning to the selection block 32. The third option at 42 permits the investor to create their own scenario. For this, the investor or user inputs, at 44, the good return levels and years and the bad return levels and years. The number of years of payments until the depletion of the account balance is computed at 36.

If the investor selects the fourth option at 46, the user may mimic the historical investment returns of any selected past period. The returns are calculated based upon standard indices for that asset class, such as the S&P 500 (Standard & Poors) for domestic equities. Other asset classes would use other indices, such as intermediate bonds, small cap equities, real estate trusts, for example. The default value is the application of the historical data for a period of 20 years, although the investor may change this in some embodiments. The investor may also be permitted to change the allocation of investments between various investment vehicles, such as treasury bill, bonds, and equities. After the user input is received, the software computes, at 48, the duration of the account balance on a year-by-year basis as payouts are made.

If the investor makes no further selections of the scenarios, at 38, the program continues to the third portion, at 50.

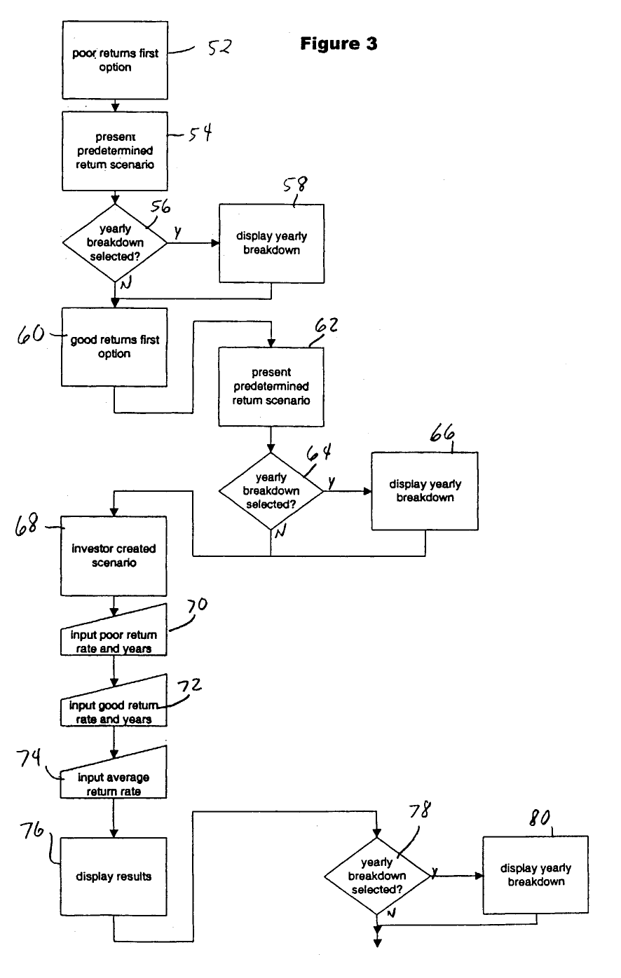

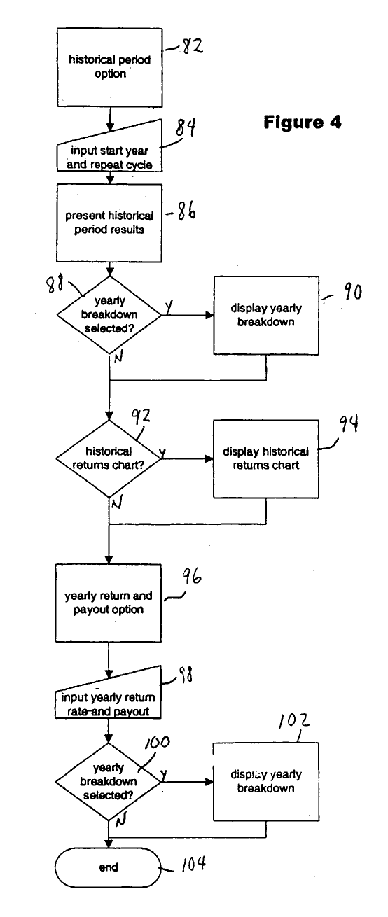

Further detail of the distribution period analysis is provided in FIGS. 3 and 4, wherein the user is offered a selection of the scenarios. In one embodiment of the software, the scenarios are presented as a menu and the following description assumes that the user or investor views each menu selection in the order presented. Of course, the user may select any menu item in any order and is not limited by the sequence presented hereinafter.

In FIG. 3, the first selection at 52 is for a post-retirement period, or distribution period, during which the investments suffer from poor investment returns at the beginning of the period. The poor returns first scenario is selected and the user is shown a predetermined return scenario, at 54. For example, the investment return rates for the years 1, 3, 5, 7 and 9 of one example are set at −10%, and the return rates for the years 2, 4, 6, and 8 are set at +20%, with an average investment return rate of 5% being applied for all other years. Software performs the necessary calculations for this scenario and reports the results to the user or investor. The user is informed of the year of depletion of the account balance and the number of years from the retirement date on which that occurred. For example, the investor may be informed that his or her investments will be reduced to zero in 14 years from retirement, which for this investor is the year 2023. The detailed breakdown can be selected by the investor at block 56, whereupon the program displays a table having a year-by-year breakdown of the account, including the year, the age of the investor, the account balance at the beginning of that year, the annual payout made that year, the investment return for that year (and an indication of whether the return is positive or negative), the estimated income tax on the payouts, and the estimated tax on the investment earnings. The detailed breakdown helps the investor to understand the effects of varying investment returns on his or her continued ability to live off the retirement account.

Having examined this information, the investor may move to the next scenario of good returns first, at 60. The program displays the results of the calculations for good returns of +20% during the years 1, 3, 5, 7, and 9 and the poor return years of −10% in the years 2, 4, 6 and 8 after retirement as the predetermined values, at 62. The remaining years are calculated at an average return of +5%. The investor is informed of the number of years that the account balances last until depletion and the year of depletion. In the example, the user is informed that the account balances will be depleted 17 years after retirement in the year 2026. Thus, this investor may draw the same amount from the account and receive three additional years of payments if the first year after retirement has a good return rather than a bad one. The investor may thus have to change the withdrawal amount, change the investment strategy, or change the retirement if early returns are not good.

If selected, at 64, the investor may see the year-by-year breakdown, at 66, which is presented in the same format as the data at block 58.

Continuing the scenarios presented to the investor, the investor selects the investor created scenario, at 68. For this option, the investor must input the poor return rate and the years to which it applies, as indicated at 70; must input the good return rate and years, as indicated at 72, and must input an average return rate to be applied to all other years, at 74. The program displays the number of years that the account balance lasts and the year that the account goes to zero, at 76. The user may then select, at 78, the year-by-year breakdown, at 80, if desired.

The program in the preferred embodiment applies cost of living increases to the withdrawal amounts so that the user considers the real spending power of the funds being withdrawn, and their effect on the balance.

Continuing on to FIG. 4, the user may view the results of the application of historical return data to his or her retirement account, at 82. The use of actual historical return rate data may be seen as more accurately representing what may really happen in the future, rather than a set of fixed numbers. The present program includes return rate data for various historical periods so that the data can be applied as desired. The user is requested to input the start year for the historical data, at 84. For example, the investor may choose to emulate the historical returns beginning in 1978, or in 1962, etc. Also at 84, the investor is asked whether historical data is to be repeated. As a default, the software applies the return data from a 20 year period after which the data is repeated in a cycle. The duration of the repeat period may also be user selectable in some embodiments.

The rate of return for the chosen historical period is displayed, along with year at which the account balance is depleted and the number of years of retirement the investor will see before depletion, at 86. For our example, the investor chooses to emulate the investment return rate beginning in the year 1978 and cycling on a 20 year interval. The investor may draw out the withdrawal amount for 2991 years before depletion. In other words, the investor learns that a similar historical period would not result in him or her outliving the retirement fund. If selected at 88 the user may view the year-by-year breakdown of the data, at 90.

The investor may also from here select, at 92, to display a chart of the historical returns, which is displayed at 94. The chart provides a visual indication of the historical performance of the investment vehicles on which the calculations are being based. This permits the investor to see if an unusually large up or down market, for example, is included in the calculation period.

As a further option, the user may choose to input the yearly return and payout amounts, at 96. The user is requested to input a return rate and a payout amount for each year, at 98, and is given the year and term of depletion. By selection, at 100, of the year-by-year display option, the user may see the effect of his or her choices, at 102. The program then ends at 104.

In an alternative embodiment, (which is similar in many respects to the embodiment just described and so is not shown for the sake of simplicity) in a first model, the user can determine the life annuity that can be purchased with the account balances. The second model provides for a projection of the account balances based on a constant rate of return and payment. The third model solves for a constant annuity payout. The fourth model available to the user illustrates the effects of variances in the annual rate of return for the investments. Lastly, the fifth model performs a projection of account balances based on varying rates of return and annual payouts.

With the first model, the model, based upon standard mortality and interest rate annuity assumptions, estimates how much annual income the account balances could purchase under an insurance company annuity. Different amounts are given for different retirement plans. The user sees the differences in the various retirement plans and has the annuity purchase as a bailout option.

In the second model, a self managed approach is set forth to show how long the user's account balances will last will depend upon the annual rate of return earned on investments and upon how much is annually withdrawn (paid) from the plan. The user is asked to input a rate of return and a payout amount and the user is shown when the balances will be depleted, both in the number of years from retirement and by the depletion date. A year-by-year breakdown is available in table form by selecting a corresponding button on the software interface.

In model three, the relationship between investment return earned, a fixed number of years for payments and the annual amount withdrawn (or paid out) is illustrated. The user enters a rate of investment return and the number of years that the user wishes to receive payouts. The amount of annual payout sustainable by the account balances at retirement is solved for. A table with a year-by-year breakdown is also available for viewing with this model. The table provides year and age information, balance, payout and investment return, as well as estimated taxes on payouts and earnings.

In model four, the effects of the timing of good and bad returns upon the depletion of the account balances is illustrated. This model assumes monthly payouts from each account equal to the annuity purchase payout amount of model one. Under one scenario, the poor returns occur in the early years of retirement. The years to depletion of resources are shown, and can be viewed in table form. In a second scenario, the good returns are in the early years of retirement, with the depletion year being displayed and a table available if desired. The user may also create his or her own scenario of rates of return. Each of these input average rates of return for some years, high rates of return for some years and a negative rate of return for other years.

Under a fourth scenario, the user may choose a historical investment period to mimic. The start date and length of the historical period is chosen as is the index on which to base the returns. The depletion date of the account balances is set forth, and a year-by-year table is available. The user may also look at a graph of the returns of the historical period chosen. In many instances, the application of a historical period to the retirement scenario presents a far more favorable outcome than the application of the scenarios described above, while selection of other historical periods my result in a less favorable outcome. Nonetheless, the results may be more realistic than attempting to choose rates of return by application of bare numbers.

The use of historical period financial information enables the user to relate knowledge about that historical period beyond the raw financial information. The user can identify with a prior period and may have reason to believe that the future may be similar to that period, without requiring economic training for the individual. Specifically, the person using the software may have lived through a historical period or be familiar with it and through an overall feel for the economic times may sense that a similar period of economic activity will occur. The user chooses that historical period for application to the modeling process, without realizing, for example, that the increases in the stock market that the user was aware of were mirrored by decreases in the bond market during that period.

A fifth model is available to the user, which allows the user to vary the rate of return and the annual payout amount on a year by year basis. The user inputs the rate of return for each year and the payout amount for each year, yielding a table showing the depletion of the account balances, etc.

This completes this part of the program, and the user may either start over or exit the program.

The investor is guided in determining an account balance and a time at which to bail out of the investment plan for the retirement account and to purchase an annuity. The annuity purchase is an option at any time for the investor, and may be the best alternative at the retirement date. However, the present invention provides a threshold level for the account balance at which the life annuity should be purchased to maintain the withdrawal stream. This not only prevents a series of poor returns from shortening the payout period, or the investor from living longer than the account balance, but it also frees the investor from worry over investments at a time in their life with they may no longer have the interest or ability to consider such things.

Thus, the present invention assists an investor by illustrating the annual income potential of account balance accumulations, balances are: a) converted at various ages using annuity purchase rates, and b) advanced on a year by year basis, with unlimited variations of investment return and unlimited variations in annual income withdrawn.

The accumulation and distribution phases reflect the differing effects of taxation upon benefits under tax qualified plans and programs and benefits under non tax qualified plans and programs. The present program also reflects the effects of inflation in developing future minimum distribution needs with cost of living inflationary adjustment. The results of accumulation phases and simulations and distribution phases and simulations are shown on a year by year basis.

The present method and software permits the individual to project assets by asset class by simulating future investment result patterns through reference to the results of specific financial indices during a specific prior period. The investor may develops multiple strategies for distribution of capital accumulations through the use of simulated annuity purchase prices and guaranteed investments. Significantly, a threshold is presented at which the investor may purchase an annuity to guarantee a future income stream.

Thus, a financial calculator and analyzing structure for forecasting, projecting, modeling, and simulating potential cash flows through the accumulation and distribution process and multiple time periods is provided. The calculator forecasts, simulates and analyzes cash flows under financial and economic systems such as those under employer sponsored, government sponsored and individually sponsored retirement and savings programs. The present analyzer takes into account accumulation and distribution contingencies and risks as they apply to an individual, which include, but are not limited to mortality probabilities, investment returns, inflation, individual earnings growth, individual savings rates, employer contributions levels, effects of investment rate guarantees and annuity insurance, effects of inflation, and the taxation differentials and effects in accumulations and distributions from tax qualified and non tax qualified arrangements, and annuity insurance. The analysis integrates the results from an all retirement plans and sources in which the individual participates and permits projection of individual results on a year by year basis based upon variables selected by the user.

The investment modeling analysis permits the user to simulate future investment results using four approaches, each with year by year illustrations. The first approach permits the user to select any uniform rate of return for all years, the second permits individual rates of return selected by the user for each year, the third approach permits the user to select from patterns of rates of return which depict ruin theory and the importance of the timing of good and bad investment returns as applied to depletion of assets, the fourth approach permits the user to project future investment results by referring to the investment performance of specific historical periods. performance of asset classes for selected time periods by substituting the historical performance is represented by standard financial indices related to respective asset classes. For example, under the fourth approach the user may project returns for the a prospective 20 year period by identifying any prior 20 year period by selecting a starting year, such as 1950 and an ending year such as 1970 and the asset class such as equities. The program preferably includes all historical returns for all major asset categories using indices, and thereby allows modeling of asset allocations as well. This allows an investor to reference investment and economic results from a prior time period as the basis for the pattern of investment returns for a prospective time period in developing projections. The indices are listed below and include for example, the S&P 500 as the pattern for equity investments, the Russel 2000 as the pattern for small cap equity investments, the Lehman bond index, as the pattern for intermediate bonds,

By modeling the amount and timing of investment returns using estimates from many sources including reference to actual indices results and statistics from familiar historical periods and events, individual users can see the effects and relationships of investment returns, payment (withdrawal) amounts, duration of payments. The model then allows the individual to develop distribution strategies and incorporate strategies for risk management utilizing stop loss approaches bases upon using guaranteed life annuities and other insurance and guaranteed investment and financial products. The distribution strategy part of the invention allows the individual to project the conversion of his accumulated projected benefits and projected capital accumulation accounts into annual income streams based upon dates projected by individual selection. In the distribution portion, the individual can model the future by specifying minimum annual income requirements, with or without inflationary cost of living adjustments. Once a minimum income amount is determined, all pre-tax and/or after tax monthly income benefits (social security, pension plan, monthly annuity benefits) are combined and compared to the desired minimum income level. If the monthly benefits are less than the selected minimum, account balance plans must be used to provide the remaining income. The distribution analysis projects the payouts from capital accumulation plans through each age. Simulated annuity purchase rates are in several ways in the distribution period. Annuities can be purchased at the beginning of the distribution period or at any time after the distribution period. Delayed purchase of an annuity is termed a deductible (i.e. the first five years are paid by the individual and the annuity is purchased after five years, or purchased immediately with payments beginning after 5 years). By simulating the cost of an annuity purchase at each age in the distribution period, the individual sees the amount of capital required to guarantee future minimum cash flow through an annuity purchase. The minimum annuity purchase amounts at each age are identified as Bailout Benchmarks allowing the individual to compare his remaining fund balance each year with the amount required to purchase an annuity and guarantee future minimum cash flow. In addition to the annuity purchase strategy, guaranteed investments such as bonds held to maturity are used as a strategy to guarantee minimum cash flow. Through the illustration of guaranteed financial products and annuity purchases projected for each age in the distribution period, the individual can forecast account balances and meet minimum retirement income amounts combining the results of all income sources and develop strategies for reducing risk, depending upon the individual's risk tolerances and financial resources.

The invention is used with electronic delivery and computing technologies through intranets, the Internet, CD-ROMs, DVDs, diskettes etc. The invention can be implemented by an employer organization and programmed to reflect the employer retirement plans which are accessed by individual employees, or can be implemented by an individual who must enter specifications regarding benefit plans in which he participates. For applications sold to employers, the present invention is expected to be customized with specific information regarding the plans and provisions through which assets accumulate. The results show calculations on an individual level, based upon group programs and individual arrangements.

The accumulation process projects and simulates the accumulation of cash and/or accrual of benefits based upon specific provisions and/or generalized plans and programs information, (depending upon the source), to points in time selected by the user, under economic and financial variables selected by the user. Simulations permit the individual user to select, estimate and project potential future performance for a specific contingency from a menu of various tables and to select potential investment performance on a uniform or average basis and on a year by year basis, allowing for variation on a year by year basis, and by allowing results from prior historical periods to be selected and used to mimic results for future periods (i.e. Standard and Poors annual returns from the 20 year period 1951 to 1970). The accumulation process develops the cash and benefit accumulations under tax deferred and non tax deferred arrangements and reflects any penalties and/or reductions which apply according to the program provisions.

The distribution phase translates the accumulation phase benefits and cash from all programs into an integrated cash flow forecast with tax and investment return effects. The user simulates multiple distribution potentials by selecting variations in amount and timing of cash payouts, by selecting variations in investment performance and by the use of guaranteed investments and annuity insurance. The illustration of year by year projected results assists the user to develop strategies which can incorporate varying levels of mortality and investment risk and incorporates the concept of retirement stop loss insurance through annuity purchase strategies and the concept of annual bailout thresholds which estimate minimum reserve requirements to guarantee a minimum level of remaining payouts through annuity purchases.

For purposes of the present invention, the term user applies to an individual, family, group or company using the present software. Reference to the user's computer include the personal computer of the user, a loaned or borrowed computer, a computer of an advisor or consultant, an employer's computer, or the like.

Although other modifications and changes may be suggested by those skilled in the art, it is the intention of the inventors to embody within the patent warranted hereon all changes and modifications as reasonably and properly come within the scope of their contribution to the art.

I claim:

1. A method for investment planning and analysis, comprising the steps of:
accepting input data regarding benefit plan, account and investment information of a user;
providing a selection of models for the user to select from, said models including rates of return for investments, at least one of said models being based on rates of return in a user selectable historical period; and
providing output data to the user based on at least one of said models selected by the user.

2. A method for investment planning and analysis, comprising the steps of:
accepting input data regarding benefit plan, account and investment information of a user;
presenting a selection of payout strategies and scenarios for the user upon retirement, said selection of payout scenarios including annuity purchase options and guaranteed investments; and
providing output data to the user based on at least one of said scenarios selected by the user.

3. A method for investment planning and analysis, comprising the steps of:
accepting input data regarding benefit plan, account and investment information of a user;
integrating substantially all capital accumulations of the user;
modeling the user's capital accumulations by applying user selected variables; and
providing output data to the user of an outcome of the modeling, the outcome being an integration of substantially all the capital accumulations of the user.

4. A method as claimed in claim 3, wherein said outcome is a total capital accumulation at a projected retirement date as selected by the user.

5. A method as claimed in claim 4, further comprising the step of:
modeling post retirement distribution of the capital accumulation.

6. A method as claimed in claim 5, further comprising the step of:
establishing a strategy by providing an option to purchase an annuity to the user upon the capital accumulation reaching a threshold during a distribution period.

7. A method as claimed in claim 3, wherein said capital accumulations being integrated include employer plans and government entitlement programs and self directed capital accumulations of the user.

8. A method as claimed in claim 3, wherein said modeling includes application of inflation and tax considerations and investment returns.

9. A method as claimed in claim 8, wherein said modeling of a future economic period is based on repeating a pattern of historical economic data from a user selected historical period.

10. A method as claimed in 8, wherein said modeling of future economic periods is based upon the grouping and timing effects of favorable and non-favorable investment events depicting the potential for depletion of capital or ruin.

11. A method for financial planning, comprising the steps of:
modeling an accumulation period of a user by applying variables selected by the user to generate an outcome in a form of an amount of accumulated capital; and
modeling a distribution period of the user, said distribution period modeling being performed by application of further variables selected by the user, said distribution period modeling starting with the amount of accumulated capital from said step of accumulation period modeling.

12. A method for financial planning, comprising
integrating substantially all current capital accumulations of a user together;
generating a model of an accumulation period of the user starting with the current capital accumulations;
generating an outcome at an end of the accumulation period for evaluation; and
modeling a distribution period of the user, said distribution period modeling starting with the outcome from the end of the accumulation period.

13. A program for running on a computer, said program operating to perform the steps comprising:
accepting input data regarding account and investment information of a user;
integrating substantially all capital accumulations of the user;
modeling the user's capital accumulations by applying user selected variables; and
providing output data to the user of an outcome of the modeling, the outcome being an integration of substantially all the capital accumulations of the user.

14. A product including a program for running on a computer, said program operating to perform the steps comprising:
accepting input data regarding account and investment information of a user;
integrating substantially all capital accumulations of the user;
modeling the user's capital accumulations by applying user selected variables; and
providing output data to the user of an outcome of the modeling, the outcome being an integration of substantially all the capital accumulations of the user.

15. A method of financial planning for a business, comprising the steps of:
accepting input data regarding capital accumulations of the business;
modeling the business's capital accumulations during an accumulation period by applying user selected variables; and
providing output data to the business of an outcome of the accumulation period modeling.
